(19) United States
(12) Patent Application Publication
(10) Pub. No.: US 2017/0168800 A1
(43) Pub. Date: Jun. 15, 2017

(54) Reporting Marine Electronics Data and Performing Software Updates on Marine Electronic Peripheral Devices

(71) Applicant: Navico Holding AS, Egersund (NO)

(72) Inventors: Thomas E.H. Isaacson, Auckland (NZ); Geoffrey E. Morrish, Auckland (NZ); David J. Fereday, Auckland (NZ)

(21) Appl. No.: 14/965,410

(22) Filed: Dec. 10, 2015

(51) Int. Cl. G06F 9/445; G06F 13/10; H04L 29/08

(52) U.S. Cl. CPC G06F 8/65; H04L 67/34; G06F 13/102

(57) ABSTRACT

Various implementations described herein are directed to technologies for reporting data and updating marine electronic peripheral device software. A reporting function that captures and saves current settings information of a marine electronics device and peripheral devices in communication with the marine electronics device is provided. The reporting function further captures and saves current information pertaining to a network that facilitates communication between the marine electronics device and the peripheral devices. A software update function that updates the peripheral devices using a cloud server and at least one member of a group consisting of: a portable storage device, the marine electronics device, and a handheld computer device is provided.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Various forms of marine electronics data may be processed and/or displayed using a computing device disposed aboard a vessel. In one scenario, the computing device may include a multi-function display (MFD). Marine electronics data displayed using the computing device may be used to help navigate the vessel, and the data may include, for example, sonar data, chart data, radar data, or navigation data.

### SUMMARY

Described herein are implementations of various technologies for reporting data and updating marine electronic peripheral device software. A reporting function that captures and saves current settings information of a marine electronics device and peripheral devices in communication with the marine electronics device is provided. The reporting function further captures and saves current information pertaining to a network that facilitates communication between the marine electronics device and the peripheral devices. A software update function that updates the peripheral devices using a cloud server and at least one member of a group consisting of: a portable storage device, the marine electronics device, and a handheld computer device is provided.

Also disclosed herein is a system for reporting data and updating marine electronic peripheral device software. A marine electronics device provides a report function that captures and saves current settings information of the marine electronics device and peripheral devices in communication with the marine electronics device. The report function further provides current information pertaining to a network that facilitates communication between the marine electronics device and the peripheral devices. A software updating means provides a software update function configured to update the peripheral devices using a cloud server and at least one member of a group consisting of: a portable storage device, the marine electronics device, and a handheld computer device.

Further disclosed herein is a non-transitory computer-readable medium having stored thereon a plurality of computer-executable instructions which, when executed by a computer, cause the computer to: provide a report function that that captures and saves current settings information of a marine electronics device and peripheral devices in communication with the marine electronics device and current information pertaining to a network that facilitates communication between the marine electronics device and the peripheral devices; and provide a software update function that updates the peripheral devices using a cloud server and at least one member of a group consisting of: a portable storage device, the marine electronics device, and a handheld computer device.

The method reporting function may be activated by a user request received at the marine electronics device or a handheld computer device in communication with the marine electronics device.

The current settings information may be diagnostics information, current errors, crash logs, system logs, internal memory size, network information of the marine electronics device and the peripheral devices.

The current settings information and the current information pertaining to the network may be captured and saved by the marine electronics device.

The current settings information and the current information pertaining to the network may be uploaded to at least one of the portable storage device, the cloud server, and the handheld computer device.

The software update function may be configured to download a software update for the marine electronics device from the cloud server to the portable storage device. The software update may be a file that includes a list of updated versions of software for the peripheral devices. In one implementation, the software update function is further configured to update the marine electronics device with the software update for the marine electronics device. In another implementation, the software update function is further configured to compare the list of updated versions of software for the peripheral devices against software versions presently installed on the peripheral devices.

The software update function may be further configured to perform a software update on the peripheral devices by: downloading peripheral device software updates to the portable storage device; transferring the peripheral device software updates from the portable storage device to the marine electronics device; and using the marine electronics device to update the peripheral devices with the peripheral device software updates.

The software update function may be further configured to cause the marine electronics device to compare a current software version file against a new software version file located on the cloud server to determine whether the peripheral device software updates are available. Based on the comparison, the software update function may be further configured to cause the marine electronics device to automatically download the peripheral device software updates and install the peripheral device software updates on the peripheral devices.

The software update function may be configured to cause the handheld computing device to download a current software version file from the marine electronics device via a local network. The software update function may be configured to cause the handheld computer device to: connect to the cloud server over an Internet connection; and download a cloud server software version file. The software update function may be configured to cause the handheld computer device to compare the current software version file to the cloud server software version file.

In one implementation, the software update function may be configured to cause the handheld computer device to download the peripheral device software updates from a third party provider when the current software version file is different from the cloud server software version file.

In another implementation, the software update function may be configured to cause the handheld computer device to download the peripheral device software updates from the cloud server when the current software version file is different from the cloud server software version file. The software update function may be configured to cause the handheld computer device to upload the peripheral device software updates to the marine electronics device when the handheld computer connects to the marine electronics device through a local area network. The software update function may be configured to cause the marine electronics device to update the peripheral devices with the peripheral device software updates.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a marine networking system in accordance with implementations of various techniques described herein.

FIG. 2 is a flow diagram of a method for reporting marine electronics data and performing updates on marine electronic peripheral devices in accordance with implementations of various techniques described herein.

FIG. 3 is a flow diagram of a method for updating software in accordance with implementations of various techniques described herein.

FIG. 4 is a flow diagram of a method for updating software in accordance with implementations of various techniques described herein.

FIG. 5 is a flow diagram of a method for updating software in accordance with implementations of various techniques described herein.

FIG. 6 is a flow diagram of a method for updating software in accordance with implementations of various techniques described herein.

FIG. 7 is a flow diagram of a method for reporting marine electronics data in accordance with implementations of various techniques described herein.

FIG. 8 illustrates a schematic of a marine electronics device in accordance with implementations of various techniques described herein.

FIG. 9 illustrates a schematic diagram of a computing system in which the various technologies described herein may be incorporated and practiced.

### DETAILED DESCRIPTION

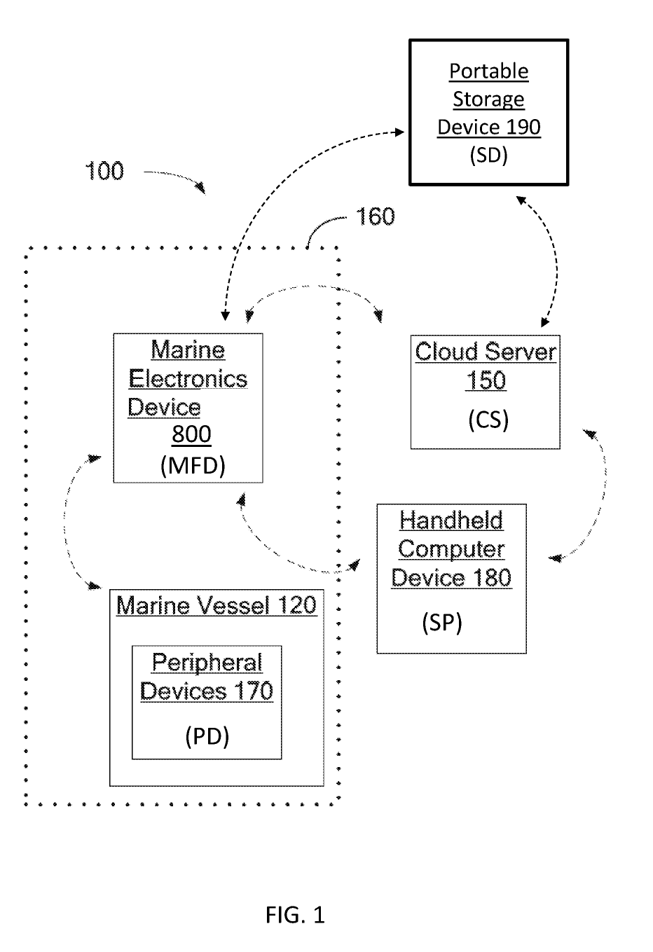

One or more implementations of various techniques for reporting marine electronics data and performing updates on marine electronic peripheral devices will now be described in more detail with reference to FIGS. 1-8 in the following paragraphs.

FIG. 1 illustrates a block diagram of a marine networking system 100 in accordance with implementations of various techniques described herein. The marine networking system 100 may include several components, such as a marine electronics device 800 (which may be a multi-function display or a chartplotter), a cloud server 150, a handheld computer device 180 (e.g., a tablet, a smartphone, a laptop or other personal computing device, etc.), a marine vessel 120, and peripheral devices 170 disposed on a marine vessel 120 that may be in communication with the marine electronics device 800. The cloud server 150 may be a server located on the Internet, which may be operated by a vendor. The cloud server 150 may also be a plurality of servers in different parts of the cloud where the plurality of servers may be maintained by a single entity, one or more third parties, or a combination of the single entity and the one or more third parties. Although server 150 is described as a cloud server 150, it is noted that implementations of the present disclosure may utilize any remotely accessible storage device(s). A web browser may be included in the user interface of the marine electronics device 800. As such, a user may use the web browser to connect to the cloud server 150 over the Internet. The marine electronics device 800 may collect data from the marine networking system 100, as well as manage and control various navigation related systems and the peripheral devices 170. For more information regarding the marine electronics device 800, see the section titled MARINE ELECTRONICS DEVICE below.

The peripheral devices 170 may include a sonar system, a Global Positioning System (GPS) device, such as a GPS receiver or a similar device such as GLONASS or global navigation satellite system (GNSS) receiver, a radar system, a propulsion system, various navigation systems, and any other systems, such as lighting systems, wireless data communication devices, wireless audio communications devices, audio and video entertainment devices, weather and environmental sensor systems, etc., disposed onboard the marine vessel 120.

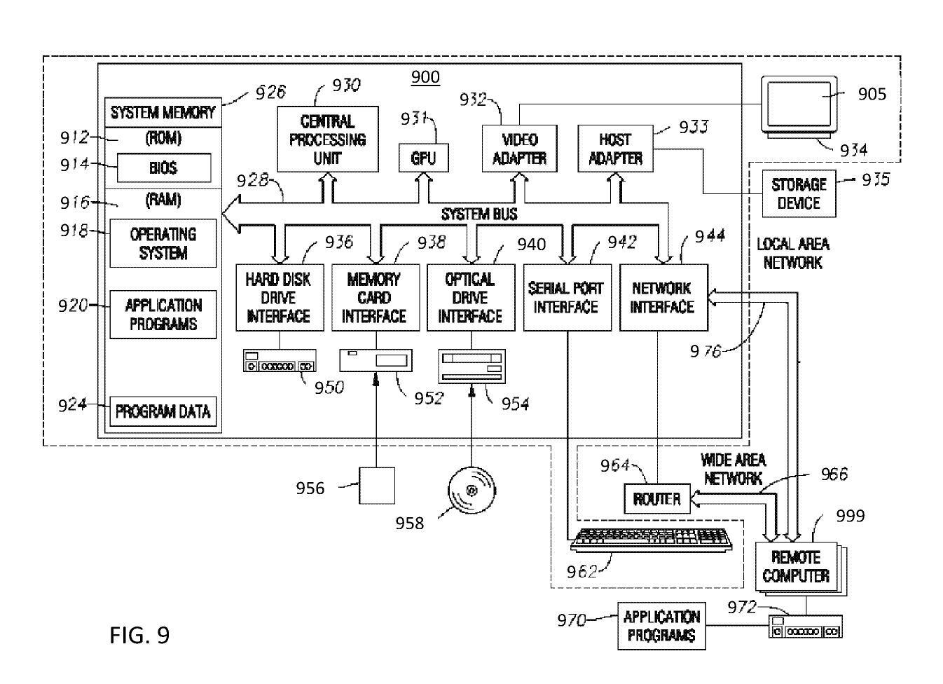

Furthermore, the marine electronics device 800 may be connected to the peripheral devices 170 over a marine network 160 operated onboard the marine vessel 120. Components on the marine network 160 may communicate using a National Marine Electronics Association (NMEA) communication protocol or other mutually compatible protocol. For instance, the router 964 described in FIG. 9 below may provide one or more network connections between components on the marine network 160. As such, the marine network 160 may be a local area network that includes the handheld computer device 180, the marine electronics device 800 and the peripheral devices 170.

The marine electronics device 800 or the peripheral devices 170 may be associated with a user or user account. As such, a respective user may set up a user account with the cloud server 150. The respective user may register the marine electronics device 800, the marine vessel 120, the handheld computer device 180, or the peripheral devices 170 to the user account. The user account may be associated with security information (e.g., an account identification, an account password, etc.), a personal profile (e.g., customer identification, such as name, address, phone number, etc.), product information (e.g., product serial numbers, the type of marine electronics device 800, the type of the marine vessel 120, and other component information such as for a radar system or sonar system, etc.), and financial information (e.g., customer billing information, credit card information, purchase history, etc.). Account information may be stored on the cloud server 150. The respective user may access and modify information stored in the user account to verify accuracy. Security measures may be put in place to maintain the respective user's privacy and protect sensitive personally identifiable information.

Optional portable storage device 190 may be used in conjunction with a separate computing device (not shown) of the user to upload/download data to/from cloud server 150. Optional portable storage device 190 may also be coupled with marine electronics device 800 to download/upload data to/from the marine electronics device.

In some implementations, the user account may be associated with an online profile, such as a profile that is visible to other users on a social networking site. The online profile may also be used to display information collected by the marine electronics device 800, the handheld computer device 180, or from the peripheral devices 170. As such, the handheld computer device 180 or the marine electronics device 800 may manage information in the online profile by changing various settings (e.g., privacy settings regarding which users, such as social media friends, are able to access the online profile, or information settings regarding what information is collected or displayed with respect to the user, etc.) or information stored in the user account. The online profile may also be synchronized with one or more respective social networking sites, where a change to information in the online profile may change the information displayed in the respective social networking sites.

### Combined Updating and Reporting

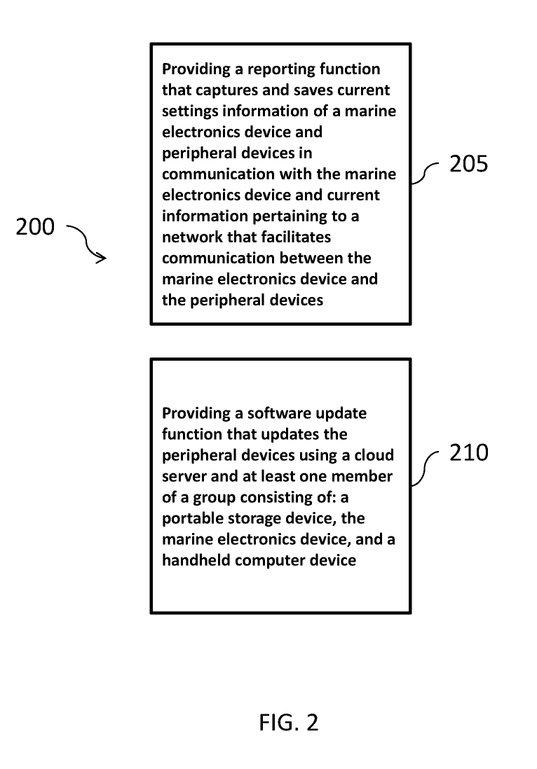

FIG. 2 illustrates a flow diagram for a method 200 for reporting data and updating peripheral device software in a marine network system in accordance with implementations of various techniques described herein. In one implementation, method 200 may be performed by the marine electronics device 800. It should be understood that while method 200 indicates a particular order of execution of operations, in some implementations, certain portions of the operations might be executed in a different order. Further, in some implementations, additional operations or blocks may be added to the method 200. Likewise, some operations or blocks may be omitted.

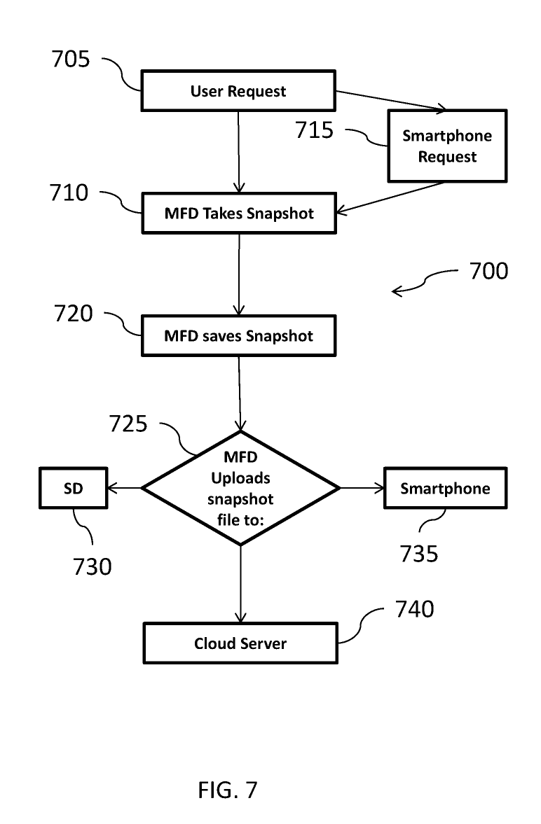

At block 205, a reporting function is provided. The reporting function captures and saves current settings information of a marine electronics device and peripheral devices in communication with the marine electronics device. The reporting function also captures and saves current information pertaining to a network that facilitates communication between the marine electronics device and the peripheral devices. The reporting function implementation is also described below in the description of FIG. 7. The request is received at the marine electronics device 800.

In one implementation, the marine electronics device 800 may be a multi-functional display (MFD) and the request may initiated by direct input from the user, e.g. actuating a button, making a selection via a touch screen, etc. The request may be a request to collect data.

The marine electronics device 800 collects, e.g., takes a snapshot of, various data. The snapshot may include current settings, system information, diagnostics information, current errors, internal memory size, network information for the marine electronics device and/or the peripheral devices, and/or system logs and/or screen shots, e.g., crash logs, radar logs, sonar logs, etc.

The marine electronics device 800 saves the snapshot in a snapshot file. The marine electronics device 800 may upload the snapshot to one or more devices 150, 180, 190. The one or more devices include, but are not limited to, a portable storage device, the handheld computer device, and/or the cloud server.

Alternatively, the request may be sent to the marine electronics device from a handheld computer device. The request may be initiated by a user of the handheld computer device. The handheld computer device 180 may be a smartphone, tablet, or any other type of portable computing device. The handheld computer device may request the marine electronics device to take the snapshot and save the data to the handheld computer device. The request may be made using either a support application or webpage on the handheld computer device.

At block 210, a software update function that updates one or more peripheral devices 170 is provided. The peripheral devices are updated using a cloud server 150 and at least one member of a group including: a portable storage device 190 (e.g., a secure digital memory (SD) card), the marine electronics device 800, and a handheld computer device 180 (e.g., a tablet, smartphone, or other portable computing device).

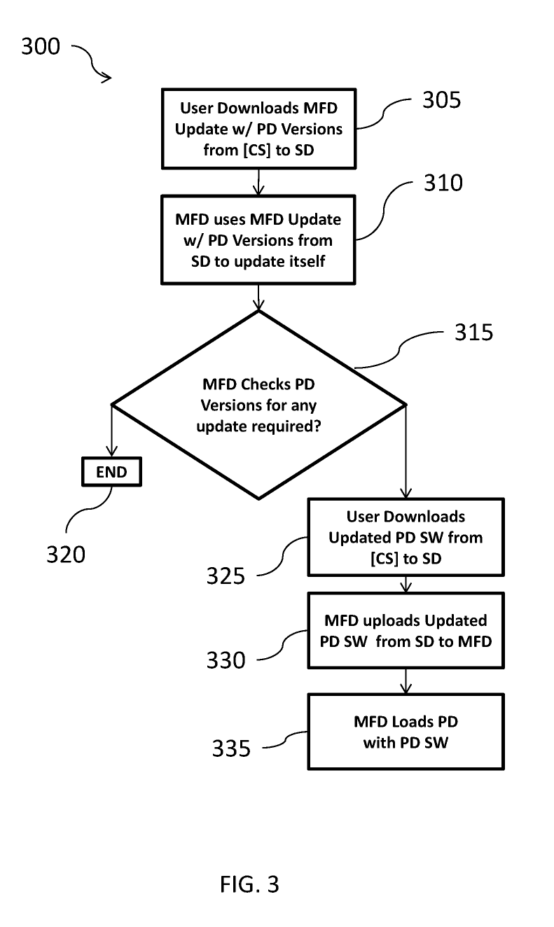

In one implementation, a portable storage device is used to update peripheral device software. This implementation is also described below in the description of FIG. 3. A user would download a marine electronics device update with peripheral device versions from the cloud server 150 to a portable storage device 190, e.g., a secure digital memory card (SD). The marine electronics device 800 is updated using the portable storage device 190. The marine electronics device update may include a file that includes a list of any updated peripheral device software versions. The marine electronics device determines whether there are updated software versions available for the peripheral devices 170 using the file. The marine electronics device 800 compares the file against the software version(s) presently installed on the peripheral device(s) 170.

If updated software for the peripheral devices 170 is present, the user connects to the Internet using a computing system and downloads the update(s) to the portable storage device 190 through the computing system. The user may subsequently manually update the peripheral device software by coupling the portable storage device 190 to the marine electronics device 800 and uploading the updated peripheral device software from the portable storage device 190 to the marine electronics device 800. The marine electronics device 800 will then update any peripheral device 170 for which a software update is available by loading that peripheral device 170 with the updated peripheral device software.

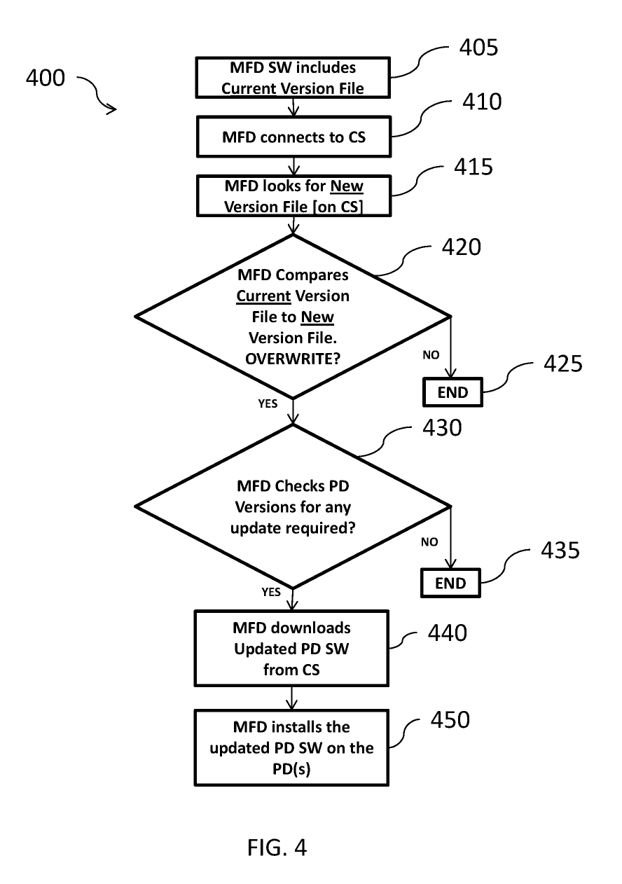

In another implementation, peripheral device software is automatically updated using a marine electronics device 800. This implementation is also described below in the description of FIG. 4. Here, the marine electronics device 800 has a current software version file, which includes a list of the current software versions of the peripheral devices 170. When the marine electronics device 800 connects to the cloud server 150, the marine electronics device 800 determines whether a new software version file is located on the cloud server 150. The new software version file includes a list of the latest software versions of the peripheral devices 170.

The marine electronics device 800 then compares the peripheral device versions in the new software version file with the current software version file to determine whether any updates are available. If the marine electronics device 800 determines that any of the peripheral device software versions has been updated, the current software version file list is overwritten by the new software version file list. The marine electronics device 800 may then automatically download the software updates for the peripheral device 170 from the cloud server 150 and installs the updates on the peripheral devices 170. In one implementation, before beginning to download the software updates for the peripheral device, the user is prompted to either begin the download or delay the download. This option is given to the user in order to delay the automatic download when the user is connected to the Internet via an expensive or limited connection.

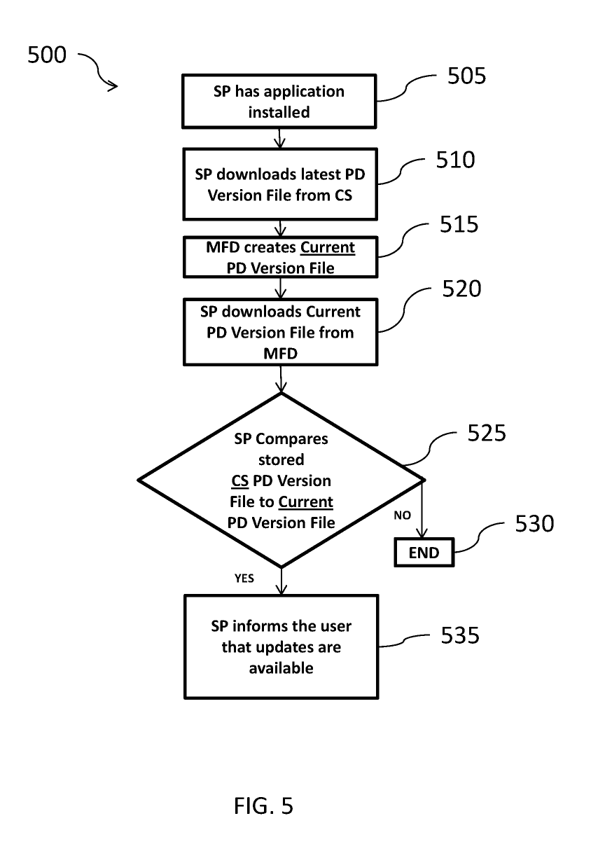

In another implementation, the user is informed of peripheral device software updates. This implementation is also described below in the description of FIG. 5. The handheld computer device 180 has an application installed thereon. The handheld computer device 180 may download a cloud server peripheral device version file, e.g., the latest peripheral device version file, from the cloud server 150, e.g., via the Internet. The marine electronics device 800 creates a current software version file. The current software version file includes a list of a current version of the marine electronics device software and current software versions of the peripheral devices 170. The handheld computer device 180 downloads the current software version file from the marine electronics device 800, e.g., via the marine network or local area network. The handheld computer device 180 compares the current software version file with the cloud server peripheral device software version file. When the peripheral device versions in the cloud server software version file include updated versions, the handheld computer device 180 inform the user that updates are available.

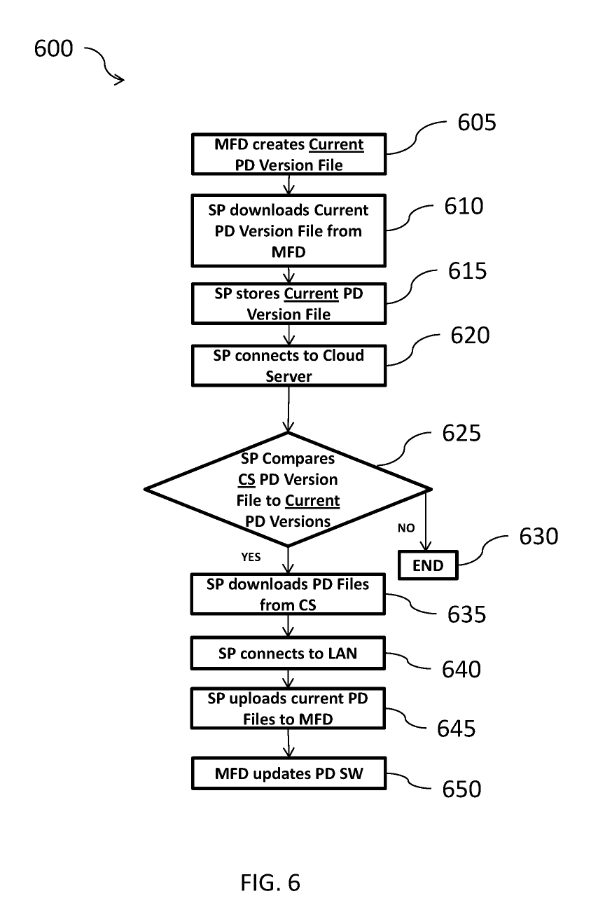

In yet another implementation, peripheral device software is updated using a handheld computer device 180. This implementation is also described below in the description of FIG. 6. As stated above, the handheld computer device 180 may be a smart phone, a tablet, or any other portable computing device. The marine electronics 800 creates a current software version file that includes the current version of the marine electronics device software and any peripheral devices. This current software version file includes a list of a current version of the marine electronics device software and current software versions of the peripheral devices. The handheld computer device 180 downloads the current software version file from the marine electronics device 800 and stores the current software version file in local memory. The handheld computer device 180 connects to the cloud server 150 via the Internet. The handheld computer device 180 then downloads a cloud server software version file that includes a list of the latest (e.g., most up to date) software versions of the marine electronics device 800 and the peripheral devices 170. The handheld computing device 180 then compares the current software version file with the cloud server software version file. If the current software version file and the cloud server software version file are different, the handheld computing device 180 then downloads any available software updates for the peripheral devices 170, e.g., from the cloud server 150 and/or third party providers 150. The handheld computer device 180 stores the updated software version(s) in local memory. When the handheld computer device 180 connects to the marine electronics device 800 through the local area network, the handheld computer device 180 uploads the current, e.g., updated, peripheral device software to the marine electronics device. The uploading of software from the handheld computer device 180 to the marine electronics device 800 may occur regardless of whether or not the handheld computer device 180 is still connected to the Internet. The marine electronics device 800 then updates the peripheral device software on the relevant peripheral devices.

### Updating Peripheral Device Software

FIG. 3 illustrates a flow diagram for a method 300 for updating software in accordance with implementations of various techniques described herein. In one implementation, method 300 may be performed by the marine electronics device 800. It should be understood that while method 300 indicates a particular order of execution of operations, in some implementations, certain portions of the operations might be executed in a different order. Further, in some implementations, additional operations or blocks may be added to the method 300. Likewise, some operations or blocks may be omitted.

At block 305, a user downloads a marine electronics device update along with peripheral device versions from the cloud server 150 to a portable storage device 190, e.g., a SD card. At block 310, the marine electronics device 800 uses the marine electronics device update along with peripheral device versions from the portable storage device 190 to update itself. At block 315, the marine electronics device 800 checks the peripheral device versions to determine whether any update is required. The marine electronics device 800 determines whether updates are available by using a file. This file may include a list of latest software versions of the peripheral devices 170. This file was received as part of the update for the marine electronics device 800 performed at step 305. This file is compared against the present software version(s) for the peripheral device(s) 170. If no updates are required, the method ends at block 320.

If updates are required, the user then downloads updated peripheral device software from the cloud server 150 to the portable storage device 190 at block 325. At block 330, the marine electronics device 800 uploads updated peripheral device software from the portable storage device 190 to the marine electronics device 800. At block 335, the marine electronics device 800 loads each peripheral device 170 for which a software update is available with the updated peripheral device software.

Also, although a SD memory card is disclosed, any portable storage device may be utilized, e.g., a universal serial bus (USB) storage device or any other type of portable storage device.

FIG. 4 illustrates a flow diagram for a method 400 for updating software in accordance with implementations of various techniques described herein. In one implementation, method 400 may be performed by the marine electronics device 800. It should be understood that while method 400 indicates a particular order of execution of operations, in some implementations, certain portions of the operations might be executed in a different order. Further, in some implementations, additional operations or blocks may be added to the method 400. Likewise, some operations or blocks may be omitted.

At block 405, it is assumed that the marine electronics device software includes a current software version file. The current software version file includes a list of the current software versions of the peripheral devices. At block 410, the marine electronics device 800 connects to the cloud server 150 via the Internet, for instance. At block 415, the marine electronics device 800 determines whether a new software version file is located on the cloud server 150. In one implementation, the new software version file includes a list of the latest software versions of the peripheral devices 170. At block 420, if the marine electronics device 800 determines that there is no new version file, the method ends at block 425.

If, at block 425, the marine electronics device 800 determines that there is a new software version file, the current version file is overwritten by the new software version file. At block 430, the marine electronics device 800 checks the peripheral device versions in the new software version file to determine whether an update is available. At block 440, the marine electronics device 800 may automatically download the updated peripheral device software from the cloud server 150 when a determination has been made that an update is available. In one implementation, before beginning to download the updated peripheral device software, the user is prompted to either begin the download or delay the download. This option is given to the user in order to delay the download when the user is connected to the Internet via an expensive or limited connection.

At block 450, the marine electronics device 800 then installs the updated software on the respective peripheral device(s) 170.

FIG. 5 illustrates a flow diagram for a method 500 for updating software in accordance with implementations of various techniques described herein. In one implementation, method 500 may be performed by the handheld computer device 180. It should be understood that while method 500 indicates a particular order of execution of operations, in some implementations, certain portions of the operations might be executed in a different order. Further, in some implementations, additional operations or blocks may be added to the method 500. Likewise, some operations or blocks may be omitted.

At block 505, the handheld computer device 180 has an application installed thereon. At block 510, the handheld computer device 180 downloads a cloud server peripheral device version file, e.g., the latest peripheral device version file, from the cloud server 150, e.g., via the Internet. At block 515, the marine electronics device 800 creates a current software version file. The current software version file includes a list of a current version of the marine electronics device software and current software versions of the peripheral devices 170. At block 520, the handheld computer device 180 downloads the current software version file from the marine electronics device 800, e.g., via the marine network or local area network. At block 525, the handheld computer device 180 compares the current software version file with the cloud server peripheral device software version file. If the peripheral device software versions in the cloud server software version file and the current software version file from the marine electronics device are the same, the method ends at block 530. If the peripheral device versions in the cloud server software version file include updated versions, the handheld computer device 180 then informs the user that updates are available at block 535.

FIG. 6 illustrates a flow diagram for a method 600 for updating software in accordance with implementations of various techniques described herein. In one implementation, method 600 may be performed by the handheld computer device 180. It should be understood that while method 600 indicates a particular order of execution of operations, in some implementations, certain portions of the operations might be executed in a different order. Further, in some implementations, additional operations or blocks may be added to the method 600. Likewise, some operations or blocks may be omitted.

At block 605, the marine electronics 800 creates a current software version file. This current software version file includes the current version of the software for the marine electronics device 800 and current software versions of any peripheral devices 170. The current software version file includes a list of a current version of the marine electronics device software and current software versions of the peripheral devices 170. At block 610, the handheld computer device 180 downloads the current software version file from the marine electronics device 800, e.g., via the marine network or local area network. At block 615, the handheld computer device 180 stores the current software version file. In one implementation, this current software version file may be stored in local memory. At block 620, the handheld computer device 180 connects to the cloud server 150, e.g., via the Internet. The handheld computer device 180 then downloads a cloud server software version file. In one implementation, the cloud server software version file includes a list of the latest (e.g., most up to date) software versions of the marine electronics device 800 and the peripheral devices 170. At block 625, the handheld computer device 180 compares the current software version file with the cloud server software version file. If the peripheral device software versions in the cloud server software version file and the current software version file from the marine electronics device are the same, the method ends at block 630. If the peripheral device versions in the cloud server software version file include updated versions, the handheld computer device 180 then downloads the updated peripheral device software from the cloud server at block 635. In one implementation, the updated peripheral device software may be downloaded from a third party provider 150. At block 640, the handheld computer device 180 connects to the local area network, e.g., LAN 976 described below in connection with FIG. 9. At block 645, the handheld computer device 180 uploads the current peripheral device software to the marine electronics device 800. At block 650, the marine electronics device 800 updates the peripheral device software on the relevant peripheral devices 170.

### Reporting Marine Electronics Data

FIG. 7 illustrates a flow diagram for a method 700 for reporting marine electronics data in accordance with implementations of various techniques described herein. In one implementation, method 700 may be performed by the marine electronics device 700. It should be understood that while method 700 indicates a particular order of execution of operations, in some implementations, certain portions of the operations might be executed in a different order. Further, in some implementations, additional operations or blocks may be added to the method 700. Likewise, some operations or blocks may be omitted.

At block 705, a request from a user is received at the marine electronics device 700. Alternatively, the user may initiate the user request by sending the request via a handheld computer device at block 715.

At block 710, the marine electronics device 700 takes a snapshot of various data. The snapshot may include current settings, system diagnostics, current errors, internal memory size, networking information, and logs and/or screen shots, e.g., crash logs, radar logs, sonar logs, etc.

At block 720, the marine electronics device 700 saves the snapshot in a snapshot file. At block 725, the marine electronics device 700 may upload the snapshot to one or more devices. The one or more devices include, but are not limited to, a portable storage device 190, the handheld computer device 180, and/or the cloud server 150.

### Marine Electronics Device

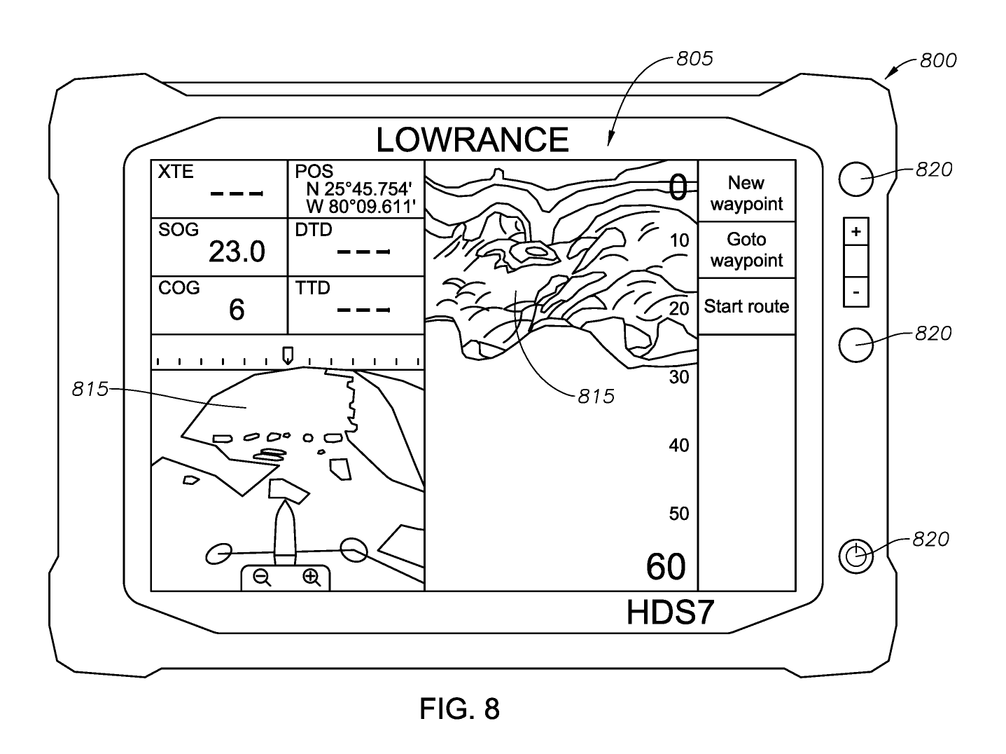

FIG. 8 illustrates a schematic diagram of a marine electronics device 800 in accordance with various implementations described herein. The components of the marine display device 800 are described in more detail with reference to the computing system 900 in FIG. 9. The marine electronics device 800 includes a screen 805. In certain implementations, the screen 805 may be sensitive to touching by a finger. In other implementations, the screen 805 may be sensitive to the body heat from the finger, a stylus, or responsive to a mouse. The display device 800 may display marine electronic data 815. The marine electronic data types 815 may include chart data, radar data, sonar data, steering data, dashboard data, navigation data, fishing statistics, vessel systems data, and the like. The marine electronics device 800 may also include a plurality of buttons 820, which may be either physical buttons or virtual buttons, or a combination thereof.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, marine electronics devices, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computer, and the like.

Various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, the global positioning system (GPS), propulsion systems, and like technologies.

Various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

Various technologies described herein may be implemented in computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

FIG. 9 illustrates a schematic diagram of the marine networking system 100 having a computing system 900 in accordance with implementations of various techniques described herein. The computing system 900 may be the marine electronics device 800, conventional desktop, a handheld device, e.g., handheld computer device 180, a controller, a personal digital assistant, a server computer, an electronics device/instrument, a laptop, a tablet, or part of a navigation system, or sonar system. It should be noted, however, that other computer system configurations may be used.

The computing system 900 may include a central processing unit (CPU) 930, a system memory 926, a graphics processing unit (GPU) 931 and a system bus 928 that couples various system components including the system memory 926 to the CPU 930. Although only one CPU 930 is illustrated in FIG. 9, it should be understood that in some implementations the computing system 900 may include more than one CPU 930.

The CPU 930 can include a microprocessor, a microcontroller, a processor, a programmable integrated circuit, or a combination thereof. The CPU 930 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 930 may also include a proprietary processor. The CPU 930 may include a multi-core processor.

The GPU 931 may be a microprocessor specifically designed to manipulate and implement computer graphics. The CPU 930 may offload work to the GPU 931. The GPU 931 may have its own graphics memory, and/or may have access to a portion of the system memory 926. As with the CPU 930, the GPU 931 may include one or more processing units, and each processing unit may include one or more cores.

The CPU 930 may provide output data to a GPU 931. The GPU 931 may generate graphical user interfaces that present the output data. The GPU 931 may also provide objects, such as menus, in the graphical user interface. A user may provide inputs by interacting with the objects. The GPU 931 may receive the inputs from interaction with the objects and provide the inputs to the CPU 930. A video adapter 932 may be provided to convert graphical data into signals for a monitor 934. The monitor 934 includes a screen 905. The screen 905 can be sensitive to heat or touching (now collectively referred to as a “touch screen”). In one implementation, the host computer 999 may not include a monitor 934. In one implementation, the CPU 930 may perform the tasks of the GPU.

The system bus 928 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral device Interconnect (PCI) bus also known as Mezzanine bus. The system memory 926 may include a read only memory (ROM) 912 and a random access memory (RAM) 916. A basic input/output system (BIOS) 914, containing the basic routines that help transfer information between elements within the computing system 900, such as during start-up, may be stored in the ROM 912.

Certain implementations may be configured to be connected to a global positioning system (GPS) 980, a sonar system 985, a radar system 987, and propulsion system 990. The GPS 980, the sonar system 985, the radar system 987, and/or the propulsion system 990 may be connected via the network interface 944. The computing system 900, the monitor 934, the screen 905, and buttons may be integrated into a console.

The computing system 900 may further include a hard disk drive interface 936 for reading from and writing to a hard disk 950, a memory card reader 952 for reading from and writing to a removable memory card 956, and an optical disk drive 954 for reading from and writing to a removable optical disk 958, such as a CD ROM or other optical media. The hard disk 950, the memory card reader 952, and the optical disk drive 954 may be connected to the system bus 928 by a hard disk drive interface 936, a memory card reader interface 938, and an optical drive interface 940, respectively. The drives and their associated computer-readable media may provide nonvolatile storage of computer-readable instructions, data structures, program modules and other data for the computing system 900.

Although the computing system 900 is described herein as having a hard disk, a removable memory card 956 and a removable optical disk 958, it should be appreciated by those skilled in the art that the computing system 900 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 900. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 900 may also include a host adapter 933 that connects to a storage device 935 via a small computer system interface (SCSI) bus, a Fiber Channel bus, an eSATA bus, or using any other applicable computer bus interface. The computing system 900 can also be connected to a router 964 to establish a wide area network (WAN) 966 with one or more remote computers 974 (e.g., the cloud server 150). The router 964 may be connected to the system bus 928 via a network interface 944. The remote computers 974 can also include hard disks 972 that store application programs 970 (e.g., the mobile content store 190).

In another implementation, as discussed in more detail with respect to FIGS. 2-6, the computing system 900 may also connect to one or more remote computers 974 via local area network (LAN) 976 or the WAN 966. When using a LAN networking environment, the computing system 900 may be connected to the LAN 976 through the network interface or adapter 944. The LAN 976 may be implemented via a wired connection or a wireless connection. The LAN 976 may be implemented using Wi-Fi technology, cellular technology, or any other implementation known to those skilled in the art. The network interface 944 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 974. It will be appreciated that the network connections shown are exemplary and other means of establishing a communications link between the computer systems may be used. The network interface 944 may also include digital cellular networks (e.g., GSM), Bluetooth, or any other wireless network interface.

A number of program modules may be stored on the hard disk 950, memory card 956, optical disk 958, ROM 912 or RAM 916, including an operating system 918, one or more application programs 920, and program data 924. In certain implementations, the hard disk 950 may store a database system. The database system could include, for example, recorded points. The database system may also include software and/or a software version list or file. The database system may further include a reporting file that captures data, e.g., a snapshot of data. The application programs 920 may include various mobile applications (“apps”) and other applications configured to perform various methods and techniques described herein. The operating system 918 may be any suitable operating system that may control the operation of a networked personal or server computer.

A user may enter commands and information into the computing system 900 through input devices such as a keyboard 962 and pointing device. Other input devices may include a microphone, joystick, game pad, satellite dish, scanner, user input button, or the like. These and other input devices may be connected to the CPU 930 through a Universal Serial Bus (USB) interface 942 coupled to system bus 923, but may be connected by other interfaces, such as a parallel port, Bluetooth, or a game port. A monitor 905 or other type of display device may also be connected to system bus 928 via an interface, such as a video adapter 932 or a wireless interface. In addition to the monitor 934, the computing system 900 may further include other peripheral output devices such as speakers and printers.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for reporting data and updating marine electronic peripheral device software, comprising:
providing a reporting function that captures and saves current settings information of a marine electronics device and peripheral devices in communication with the marine electronics device and current information pertaining to a network that facilitates communication between the marine electronics device and the peripheral devices; and
providing a software update function that updates the peripheral devices using a cloud server and at least one member of a group consisting of: a portable storage device, the marine electronics device, and a handheld computer device.

2. The method of claim 1, wherein the reporting function is activated by a user request received at the marine electronics device or a handheld computer device in communication with the marine electronics device.

3. The method of claim 1, wherein the current settings information comprise diagnostics information, current errors, crash logs, system logs, internal memory size, network information of the marine electronics device and the peripheral devices.

4. The method of claim 1, wherein the current settings information and the current information pertaining to the network are captured and saved by the marine electronics device.

5. The method of claim 1, wherein the current settings information and the current information pertaining to the network are uploaded to at least one of the portable storage device, the cloud server, and the handheld computer device.

6. The method of claim 1, wherein the software update function is configured to download a software update for the marine electronics device from the cloud server to the portable storage device, wherein the software update comprises a file that includes a list of updated versions of software for the peripheral devices.

7. The method of claim 6, wherein the software update function is further configured to update the marine electronics device with the software update for the marine electronics device.

8. The method of claim 6, wherein the software update function is further configured to compare the list of updated versions of software for the peripheral devices against software versions presently installed on the peripheral devices.

9. The method of claim 1, wherein the software update function is further configured to perform a software update on the peripheral devices by:
downloading peripheral device software updates to the portable storage device;
transferring the peripheral device software updates from the portable storage device to the marine electronics device; and
using the marine electronics device to update the peripheral devices with the peripheral device software updates.

10. The method of claim 1, wherein the software update function is further configured to cause the marine electronics device to compare a current software version file against a new software version file located on the cloud server to determine whether the peripheral device software updates are available.

11. The method of claim 10, wherein, based on the comparison, the software update function is further configured to cause the marine electronics device to automatically download the peripheral device software updates and install the peripheral device software updates on the peripheral devices.

12. The method of claim 1, wherein the software update function is configured to cause the handheld computing device to download a current software version file from the marine electronics device via a local network.

13. The method of claim 12, wherein the software update function is configured to cause the handheld computer device to:
connect to the cloud server over an Internet connection; and
download a cloud server software version file.

14. The method of claim 13, wherein the software update function is configured to cause the handheld computer device to compare the current software version file to the cloud server software version file.

15. The method of claim 14, wherein the software update function is configured to cause the handheld computer device to download the peripheral device software updates from a third party provider when the current software version file is different from the cloud server software version file.

16. The method of claim 14, wherein the software update function is configured to cause the handheld computer device to download the peripheral device software updates from the cloud server when the current software version file is different from the cloud server software version file.

17. The method of claim 16, wherein the software update function is configured to cause the handheld computer device to upload the peripheral device software updates to the marine electronics device when the handheld computer connects to the marine electronics device through a local area network.

18. The method of claim 17, wherein the software update function is configured to cause the marine electronics device to update the peripheral devices with the peripheral device software updates.

19. A system for reporting data and updating marine electronic peripheral device software, comprising:
a marine electronics device that provides a report function that captures and saves current settings information of the marine electronics device and peripheral devices in communication with the marine electronics device and current information pertaining to a network that facilitates communication between the marine electronics device and the peripheral devices; and
a software updating means that provides a software update function configured to update the peripheral devices using a cloud server and at least one member of a group consisting of: a portable storage device, the marine electronics device, and a handheld computer device.

20. A non-transitory computer-readable medium having stored thereon a plurality of computer-executable instructions which, when executed by a computer, cause the computer to:
provide a report function that that captures and saves current settings information of a marine electronics device and peripheral devices in communication with the marine electronics device and current information pertaining to a network that facilitates communication between the marine electronics device and the peripheral devices; and
provide a software update function that updates the peripheral devices using a cloud server and at least one member of a group consisting of: a portable storage device, the marine electronics device, and a handheld computer device.
